(19) United States
(12) Patent Application Publication
(10) Pub. No.: US 2006/0183100 A1
(43) Pub. Date: Aug. 17, 2006

(54) Method for processing interactive collaborative learning for a group of people

(76) Inventors: Miguel Nussbaum Voehl, Santiago (CL); Patricio Rodriguez Valdes, Santiago (CL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/335,814

(22) Filed: Jan. 20, 2006

Related U.S. Application Data
(60) Provisional application No. 60/649,143, filed on Feb. 3, 2005.

(51) Int. Cl. G09B 3/00

(52) U.S. Cl. 434/350

(57) ABSTRACT

A method for processing interactive collaborative learning for a group of people (class), visually present and a teacher that supervises them. The teacher and each student works with a wired or wireless networked devices. The class is divided in a set of groups that are visually present. The method allows the group members, mediated by their devices, to interact for solving problems and answering questions that can be solved only collaboratively. The role of the networked devices is to present information on each of the participants' electronic display devices, transmit information between the group members, apply the rules of the application stored in each device considering the information of each of the members of the group stored in each of the participants device, and transmit the transactions performed by the group to the teachers device in order to store the group log and display the group outcome at each moment to monitor its progress. The method includes one collaborative way of answering questions and three forms of collaborative problem solving.

### FIELD OF THE INVENTION

This application claims the benefit of the filing date of U.S. Provisional Application Serial No. 60/649,143 filed Feb. 3, 2005, which is incorporated by reference herein.

A collaborative activity can be defined as the commitment of a group of participants in a coordinated effort to reach a specific objective. The interactive collaborative learning for a group of people visually present has the aim of transforming the classroom dynamics from a teacher-centered arrangement, where students are passive, to one enabling collaboration and interaction between students and teacher

A method for processing interactive collaborative learning for a group of people, said method using a computer system to mediate a group of people that interact for solving problems and answering questions. The method includes collaborative ways of answering questions and solving problems.

A computer system is used in the collaborative work to:
Control interactions between the participants.
Provide a space for organizing materials and information.
Coordinate and synchronize the students' activity states.
Mediate the activities and the social interaction of the participants.
Provide the required information to solve the different students' tasks.
Provide the teacher with the currents students' status in order to monitor the activity to allow him/her adequate group mediation.

Additionally the invention comprises a method to automatically recover a working session performed using the computer system if any device malfunctions.

### BACKGROUND OF THE INVENTION

Studies suggest that when students work in groups in a collaborative context, i.e., Collaborative Learning (CL), better academic results are obtained because the students learn more, retain longer what they have learned, develop abilities of superior reasoning and critical thought and feel more valued and confident.

The creation of an effective CL environment depends on the following five key factors:
Individual responsibility: Each member must be responsible for his or her own work, role and effort to learn.
Mutual support: Each member must help to teach other members of the group.
Positive interdependence: The main goal of collaborative activities is the group goal. Therefore, collaboration is considered a success when every member of the group has interacted and has accomplished their individual goal.
Social face-to-face interactions: The decision-making process must include discussions between all collaborators. Productivity is therefore influenced by the ability of the group to efficiently exchange opinions, negotiate and construct an answer together.
Formation of small groups: Communication, discussion and achievement of consensus can be only carried out in small groups, and each member of the group must be physically close to the other members.

The incorporation of technology into Collaborative Learning brings us Computer Supported Collaborative Learning (CSCL) environments in which the technology is used to control interactions between the participants. Technology provides information, regulates tasks, administrates rules and roles, and mediates in the acquisition of new knowledge.

Most CSCL applications are implemented for personal computers and require that the participants be physically located behind the computer screen. Thus, when a CSCL activity is performed within a single space such as a school classroom, these applications do not allow for the development of face-to-face interactions, key factor for obtaining good results in a collaborative work group. By contrast, wirelessly interconnected handheld computers (such as Palm and Pocket PC devices) enable a mobile environment of collaboration to form in a natural manner. Such an environment facilitates face-to-face interactions due to the physical characteristics of the small devices and the mobility that permits the creation of wireless networks.

### SUMMARY OF THE INVENTION

The present invention is related to a method for processing interactive collaborative learning for a group of people who are preferably visually present. The method uses a computer system to mediate a group of people that interact for solving problems and answering questions in a collaborative manner.

The method includes a collaborative way of answering questions and solving problems.

In some embodiments the method for processing interactive collaborative learning applications or activities for a group of people who are preferably visually present and preferably with a teacher supervising them comprises providing wired or wireless networked devices to all members of the class that are visually present; then the group members, mediated by their devices, and/or controlled by the teacher, interact for solving problems or answering questions that can be solved collaboratively.

The group devices transmit the transactions performed by the group to the teacher's device in order to store the group log and display the group outcome at each moment.

Additionally the present invention comprises a method to automatically recover a session from a slave networked device that malfunctioned and a method to automatically recover the master within an active session in which the new master restores the state and the communication with the network that the malfunctioning master already had when the network ID was selected.

### DETAILED DESCRIPTION OF THE INVENTION

This invention relates to a method for processing interactive collaborative learning applications or activities for a group of people preferably visually present and optionally with a teacher that supervises them.

The method comprises the steps of downloading to the master device used preferably by a teacher the application with the corresponding data, wherein said application can be stored preferably in a computer or a web site, providing wired or wireless networked devices to all members of the class; sending from the master device to the different slave or students' devices a previously selected activity; preferably forming a set of groups with the students of the class, wherein the group members, mediated by their devices, and preferably controlled by the teacher, interact for solving problems or answering questions that can be solved collaboratively.

The group devices transmit the transactions performed by the group to the master device in order to store the group log and display the group outcome at each moment, and when the teacher finishes the current activity optionally he/she can select another activity and send it to the students, or alternately he/she can terminate the collaborative activity.

In accordance with the invention, the applications or activities downloaded to the master device are created, selected and downloaded preferably using a web site, wherein said step of creating the applications or activities comprises selecting and ordering the objects from an existing set in the web site, indicating how the objects selected will interact in the activity from previously existing modes and saving the activity. The steps of selecting and downloading said created activity comprise searching for the activity in the web site; and marking the activity for downloading; then repeating the above steps until all the desired activities are found and marked for downloading. When the teacher commands, only the marked activities are downloaded to the master device, and once the downloading process ends the activities are ready to be used in the master device.

In accordance with the method, the step of providing wired or wireless networked devices to all members of the class comprises providing a networked device to each student; the teacher specifying in the master device the class identifier which returns to the device a network ID, preferable related to the selected class; each student logging into his/her networked device using the ID provided by the teacher; the teacher, using the master device, searching and connecting all the available devices that match with the provided ID, thereby creating a network with the students' devices or a session.

In the method, the step of sending an activity comprises, after the master device creates a session as is indicated above, the steps of the teacher selecting in the master device a previously downloaded activity; the teacher sending the selected activity to all the slave devices that belong to the same session while transmitting and monitoring the progress of the data packages in the master device; the teacher starting the activity once the transmission finishes; afterwards, each user logging into his/her slave device thereby identifying himself/herself during the activity by entering an individual ID; and, once the slave devices receive the activity, the devices uncompressing and executing it.

Additionally, in accordance with the invention, the master device can control the work of each group or the whole class. The control of each group allows one to run an activity, stop an activity or go to a specific part of the activity. Moreover the master device can create groups of slaves according to the collaboration mode of the activity, which may be specified by the teacher or randomly assigned, and can send the same or different data to each of the groups. The master device can also disband said groups independently or simultaneously.

In some embodiments of the invention the system determines the group composition, indicating in each machine an ID of the group to which it belongs, or alternately the teacher may specify the group composition.

Usually the teacher receives in his/her networked device the information of the advancement and outcome of each activity of each group, in order to mediate those groups that need assistance.

In some embodiments the method for answering multiple-choice questions collaboratively comprises the steps of preferably arranging students in groups, with each student having a slave device which is networked in a session with the other group members and with the master device of the teacher; each member of the group receiving the same question with the same multiple answers; the members of the group being required to reach a unanimous agreement before answering the question task controlled by the networked devices; when the members of a group do not agree on an answer, the networked devices of each member continuing to ask the same question until everyone in the group concurs or after a specified number of iterations; once all members of a group agree on an answer, the networked devices validate the answer, thereby informing each member of the group and the teacher if it is right or wrong; and then the teacher receiving in his/her networked device the outcome of each question from each group.

Optionally when the group's answer is incorrect, the networked device of each group member informs them of the corresponding error and asks the group to answer the same question, with the previously selected erroneous alternative now preferably excluded, until the correct response is provided. Once all the members of the group select the correct answer, or after a pre-specified number of iterations, the group can then proceed to the next question of the activity.

In another preferred embodiment students are preferably arranged in groups, each student having a slave device networked in a session to the devices of other members of the group and to the master device of the teacher. Each member of the group receives several sets of objects and a scope between the sets that has to be accomplished. The objects belonging to a given set of one group member can be sent to the same set or a different set belonging to another group member, depending on the scope of the activity and only if the receiving group member accepts it. The members of the group have to exchange objects until all group members agree that the scope between the sets is accomplished for each of the members. Once all group members agree that the scope between the sets of objects has been accomplished, or after a pre-specified number of iterations, the networked devices validate the answer, informing each group member if the scope between the sets has been achieved and also informing the master device. When the scope between the sets of objects has not been accomplished for one or more group members, usually the task is repeated. When all the members of the group achieve the scope of the activity, or after a pre-specified number of iterations, the group can proceed to the next task. The teacher receives in his/her networked device the, outcome of the object exchange of each group in order to mediate those groups that need assistance.

In some embodiments the scope of the activity is that each member of the group receives two set of objects and a specified logic between both sets that has to be accomplished.

In some embodiments the logic of the activity is that one of the sets is questions and the other set is answers. The group members have to interchange answers until each answer of the networked device corresponds to the question of the same networked device.

In some embodiments the scope of the activity is that one of the sets is preferably one or more goals to achieve and the other set is preferably objects that in combination reach the goal. For example said combination can be any set operation, mathematical operation, or a combination thereof.

In some embodiments the scope of the activity is that one of the sets is preferably one or more goals to achieve and the other set is preferably objects that ordered by physical dimensions in ascending or descending order, or/and numbers or letters that ordered in ascending or descending order, reach the aim.

Another preferred embodiment is the method comprising the steps in which students are preferably arranged in groups, each student having a slave device networked in a session to the devices of other members of the group and to the master device of the teacher and each group member receives one or more objects. The group members have to discover the correct sequence of the objects according to a specific scope provided to them. One member of the group selects one of the objects presented in his/her networked device and the selected object is shown to all the members in their networked devices. The above step is repeated by another member of the group until all objects are selected and/or the scope is achieved. Afterwards, the networked devices validate the obtained sequence of objects and inform the group members and the teacher, through their respective devices, of whether the obtained sequence achieves the specified scope. When the correct sequence of objects is obtained, or after a pre-specified number of iterations in which the group tries again to solve the unsolved quiz, the group can proceed to the next task.

In accordance with the previous embodiment the scope of the activity is for example order sets of numbers in ascending or descending order, construct words from syllabus, construct geometrical or another graphical object from components, or order objects according to physical dimensions in ascending or descending order.

Another preferred embodiment is the method comprising the following steps: students are preferably arranged in groups, each with a slave device networked in a session to the devices of other members of the group and to the master device of the teacher; the teacher sends to all the students the same problem to solve; the students write their solution on the screen of their networked devices or use the built in simulator of the networked device to solve the problem; then the group members have to reach an unanimous agreement on which is the right response from among the answers they have wrote on the screens or obtained with their simulators of their networked devices, before replying to the teacher. If all of them agree on an answer, the agreed answer is sent to the teacher. If they all agree upon an answer that is different than the one that each member developed independently, then one group member is selected randomly by the device network to submit the group answer by writing it down on his/her screen or use the built in simulator of the networked device to obtain the group answer; the group answer is then sent to the teacher's device. Once the teacher receives all group answers she/he can optionally select a set of answers to be discussed by the class. In accordance with the above embodiments, the discussion mode between teacher and students consists of the teacher polling preferably a subset of the answers sent by the students. After the poll, the teacher can randomly select (action performed by the networked devices of the group) a student to endorse his/her vote in front of the class to generate a class discussion.

Alternatively the discussion mode between teacher and students consists of randomly selecting one of the students from the group that sent a given answer (action done by the networked devices of the group) to support his/her reply in front of the class to provoke a class discussion.

Another preferred embodiment is the method comprising the following steps: students are preferably arranged in groups, each with a slave device networked in a session to the devices of other members of the group and to the master device of the teacher; the teacher sends to all the students an activity in which every member of the group has a specific role allowing him/her to interact with his/her partners in the group, The task of the activity has to be solved collaboratively by the interactions of the members of the group, which perform actions which are transmitted to the other members of the group.

In accordance with the previous embodiment, the activity can be a videogame, where each member of the group commands an assigned character with specific features and roles and the exchanged information between members of the group are the actions of each character which are reflected in each screen of the devices of the group.

In accordance with the invention, usually the display of online transactions in the master device is done through a matrix. The matrix rows correspond to the different group that are performing the activity, and the columns correspond to the coded answers to each task, or alternately the matrix columns correspond to the different groups that are performing the activity, and the rows correspond to the coded answers to each task. Said code is done with symbols, for example symbol1 if the group solves the scope correctly at the first try, symbol2 if the number of trials are between 2 and ┌n/2┐ (n being the pre-specified number of iterations) and symbol3 if the number of trials are between ┌n/2+1┐ and n. Unanswered questions are, for example, codified with symbol4. If the scope were not solved within the pre-specified number of iterations these questions are also codified with symbol4.

Said symbols are, for example, the following: symbol1 is a green colored rectangle, symbol2 is a yellow colored rectangle, symbol3 is a red colored rectangle and symbol4 is a grey colored rectangle.

In accordance with the invention the pre-specified number of iterations in which group members must correctly answer a question is predetermined in the software or by the teacher in his/her master device for each specified group or for all groups simultaneously.

Another aspect of the invention is the role of the networked devices in the method, said role comprising: to present information on each of the participants' electronic display devices, to transmit information between the group members, to apply the rules of the application stored in each device considering the information of each of the members of the group stored in each of the participants device, and to transmit the transactions performed by the group to the teacher's device in order to store the group log and display the group outcome at each moment to monitor its progress.

Another aspect of the invention is a method for connection of a slave to the master after an activity has started or is in execution, said method comprising the following steps: the student logs into his/her networked device with the ID provided by the teacher that corresponds to the same ID used by all other devices on the same network; then the master networked device, automatically and without teacher intervention, sends the current activity and the corresponding state belonging to the new slave, incorporating it into the groups according to the rules of the activity.

The present invention is also related with a method to automatically recover a session from a slave networked device that malfunctions, loses data or loses its connection with the master, said method comprising the following steps: the master and slaves devices will try to reestablish the previously existing connection automatically; when the previous step fails, or the networked device(s) malfunctions, the networked device(s) have to be reset; and after being reset the network ID and the individual ID are entered into the networked device(s).

Another aspect of the invention is a method to automatically recover the master within an active session. The new master restores the state and the communication with the network that the malfunctioning master previously had when the network ID was selected.

The present invention is also related with a method to automatically update the slave and master devices with a new version of the system, downloaded preferably from the website, and a new version of the activities created using preferably the website, said method comprising the following steps: synchronizing the master with the website; then downloading a new version of the system and/or activities; once downloaded automatically, installing the new version in the master; and the master updating the slaves in the next session.

Having described some embodiments of the invention, one with ordinary skill in the art will now realize further features and advantages of the invention from the above described embodiments. It should be understood, therefore, that the foregoing is only illustrative of the principles of the invention and that various modifications can be made by those skilled in the art without departing from the scope and spirit of the invention. Accordingly, the invention is not to be limited by the above description.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding U.S. Provisional Application Serial No. 60/649,143, filed Feb. 3, 2005, are incorporated by reference herein.

The preceding examples can be repeated with similar success by substituting the generically or specifically described reactants and/or operating conditions of this invention for those used in the preceding examples. In the foregoing and in the examples, all temperatures are set forth uncorrected in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A method for processing interactive computer supported collaborative learning applications (activities) for a group of people (class) visually present with each other and a teacher that supervises them, comprising the steps of: a) creating and selecting from a web site collaborative learning applications with the corresponding data and download them from the Internet to the teacher's device (master); b) providing a wired or wireless networked device to all members of the class that are visually present; c) forming a set of groups with members that are visually present, by creating groups of slave devices according to the collaboration mode of the activity; d) sending from the master to the different students' devices (slaves) a previously selected activity, being able to send each of the groups the same or different data and/or application; e) the group members, mediated by their devices, and/or controlled by the teacher, interact for solving problems or answering questions collaboratively; f) the group devices transmit the transactions performed by the group to the teacher's device in order to store the group log and display the group outcome at each moment, and g) the teacher can finish an activity by groups independently or all groups simultaneously; afterwards, she/he can select another activity and send it to the students or stop the network connection; h) the teacher uploads from his/her device to the web site the different groups results (log).

2. A method as in claim 1, wherein to create activities comprising the following steps: a) selecting and ordering the objects from an existing set in the website; b) indicating how the objects selected in a) will interact in the collaborative activity from previously existing modes (collaboration modes) c) saving the collaborative activity allowing to anybody with the corresponding access to the web site, see the created activity.

3. A method as claim 1, wherein for downloading previously created activities, according to existing collaboration modes, comprising the following steps that the teacher performs: a) searches an activity in the website from the available ones according to his/her access profile; b) selects the activity he wants to use in a collaborative session; c) repeats steps a and b until all the desired activities were found and marked for downloading; d) connects the master device to the website, synchronizing it automatically; e) commands to download only the selected activities to the master device from the web site; and f) once the downloading process ends, activities are ready to be used in the master device.

4. A method as in claim 1, wherein the steps of providing a wired or wireless networked devices to all members of the class are the following: a) each student receives a networked device; b) the teacher specifies in the master device the class name returning the device a network ID related to the selected class; c) each student logs in his/her networked device with the ID provided by the teacher, d) the teacher, using the master device, searches and connects all the available devices that match with the provided ID, creating a network with the class (session).

5. A method as claim 1, wherein the steps of sending an activity are the following: a) once the master device creates a session the teacher selects in the master device a previously downloaded activity, b) the teacher sends, the selected activity to all the slave devices that belong to the same session transmitting and monitoring the master device the progress of the data packages, c) the teacher starts the activity once the transmission finished; d) afterwards, each user logs in his/her slave device individualizing himself/herself during the activity, entering an individual ID; e) once the slaves received the activity, they uncompress it and then execute it;

6. A method as claim 1, where the group members, mediated by their devices, interact according to a collaboration mode for solving problems or answering questions that can be solved collaboratively, where during the collaborative work, the devices produce on line transactions, i.e., statistics about the activity for the master, for each slave or group of slaves, the state of the network and the hardware (results), these results reflect the outcome of the collaborative work.

7. A method as in claim 1, wherein is useful to control the work of each group or the whole class from the master device, wehere said control allows running an activity, stopping an activity and going to a specific part of the activity.

8. A method as claim 1, where the devices transmit the transactions performed by the groups to the teacher's device (master device) in order to store the group's activity log and outcome and display at each moment each group outcome and online transactions.

9. A method as claim 1, wherein the steps where the teacher uploads from his/her device to the website the transactions produced by the collaborative work are the following; a) The obtained results can be seen in the teacher's device (master), results that can be edited by the teacher; b) the teacher connects the master to the website and the master device is synchronized, uploading the results to the website. c) Anybody with the corresponding access can see at anytime in the website the uploaded results.

10. A method as claim 4, where the connection of a slave to the master can be performed after an activity has started or is in execution, performing the following steps: a) The student logs on his/her networked device with the ID provided by the teacher that corresponds to the same ID used by all other machines of the same network; b) The master networked device, automatically and without teacher intervention, sends the current activity and the corresponding state belonging to the new slave, incorporating it to the groups according to the rules of the activity; c) if the activity requires, the student logs in the slave device using his/her individual ID.

11. A method to automatically recover a session from a slave networked device, wherein the broke down, lost data or lost connection with the master, compromising the following steps: a) In case of data or connection lost, both the master and slaves devices will retry to establish the previously existent connection automatically; b) When a) fails, or the networked device(s) break down, the networked device(s) have to be reset; c) after reset the network ID and the individual ID are entered into the network device;

12. A method to automatically recover the master within an active session, according to claims 11 wherein the new master restores the state and the communication with the network that the broken master already had when the network ID was selected.

13. A method, as in claim 4, wherein to manually recover transactions performed by the devices when they are not properly transmitted, compromising the following steps: a) selecting in the master device, the activity that does not previously recover all the results, b) create a session with all the slaves involved in the class; c) once the session is created, and when the user commands it, all the missing results are recovered; d) the master is ready to repeat the process with another activity; e) results are ready to be uploaded to the website.

14. A method, as in claim 1, wherein to automatically update from the web site the slave and master devices with a new version of the system and/or a new version of the activities compromising the following steps: a) synchronize the master with the website, downloading a new version of the system and/or activities; b) once downloaded automatically, the new version is installed in the master; c) the master actualizes the slaves in the next session.

15. A method as in claim 1, wherein the groups can: a) Have random assignment performed by the system; i.e., the system determines the group composition indicating in each machine an ID that indicates the group of the students belongs to (group ID); b) Be specified by the teacher, i.e., he/she specifies the group composition by stipulating the group composition in the master device transmitting to the different student machines how they are grouped indicating in each machine an ID that defines the group the student belongs to; c) Be specified by the students indicating in their machines to which group they belong through the specification of a group ID.

16. A method as in claim 1, wherein the collaboration mode, includes a method for answering multiple-choice questions collaboratively on the group members networked devices, compromising the following steps: a) Students are arranged in groups, each with a slave device networked in a session to the other members and to the master device of the teacher; b) Each member of the group receives the same question with the same multiple options from the activity stored in their networked devices, not necessarily ordered in the same way; c) The members of the group must reach an unanimous agreement before answering the question which is controlled by the networked devices; d) When the members of a group do not agree on an answer, the networked devices of each member keeps asking the same question again until everyone in the group concurs; e) Once all members of a group agree on an answer, the networked device of each member validates the answer, informing the members and the teacher if it's right or wrong; f) The teacher receives the information of the outcome of each question of each group in its networked device, to mediate those groups that need assistance; g) When the answer of a group is incorrect, the networked device of each group member informs the corresponding error and asks the group to answer the same question, with the previously selected erroneous alternative now excluded, until the correct response is arrived at; h) Once all the members of the group select the correct answer, or after a pre-specified number of iterations, the group can then proceed to the next test question, where the number of pre-specified number of iterations the group members have to answer correctly a question is predetermined: I) in the software; or II) by the teacher in his networked device for each specified group or for all groups simultaneously.

17. A method as claim 8, wherein the display of online transactions is done through a matrix, where said matrix rows correspond to the groups created running the activity, and the columns correspond to the tasks answers that are coded, otherwise, the matrix columns correspond to the groups created running the activity, and the rows correspond to the tasks answers that are coded, where said code is done with symbols: symbol1 if the group solves the scope correctly at the first try, symbol2 if the number of trials are between 2 and ┌n/2┐, (being n the number of the pre specified number of iterations) and symbol3 if the number of trials are between ┌n/2+1┐ and n, where nanswered questions are codified with symbol4 and if the scope was not solved with the pre-specified number of iterations is also marked with symbol4. Symbol1, symbol2, symbol3 and symbol4 can be any combination of different colors, wherein for instance, symbol1 can be a green colored rectangle, symbol 2 can be a yellow colored rectangle, symbol3 can be a red colored rectangle and symbol4 is a grey colored rectangle.

18. A method as claim 2, wherein the collaboration mode includes a method for interchanging objects between group members, compromising the following steps: a) Students are arranged in groups, each with a slave device networked in a session to the other members and to the master device of the teacher; b) Each member of the group receives several sets of objects and a scope between the sets that has to be accomplished, said scope of the activity can be that each member of the group receives two set of objects and a specified logic between both sets that has to be accomplished. The logic between both sets could be: I) That one of the sets are questions and the other set are answers and the group members have to interchange answers until each answer of the networked device corresponds to the question of the same networked device; II) That one of the sets is one or more scopes to achieve and the other sets are objects that combined reach the scope, said combination of objects can be: 1) Any mathematical or logical operation, or its, combination; 2) Any set operation, or its combination; III) That one of the sets is one or more scopes to achieve and the other sets are objects that ordered reach the scope; IV) That one of the sets is one or more scopes to achieve and the other sets are numbers or letters that ordered, in ascending or descending order, reach the scope; V) That one of the sets is one or more scopes to achieve and the other sets are objects that ordered, by physical dimensions in ascending or descending order, reach the aim; c) The objects belonging to the given set of any of the members of the group, can be sent to the same set, or another set, of another member of the group, depending on the scope of the activity. d) The members of the group have to exchange objects until all group members agree that the scope between the sets is accomplished for each of the members; e) Once all group members agree that the scope between the sets of objects has been accomplished, the networked devices validate the answer, informing each group member if the scope between the sets has been achieved, and also informing the master device; f) When the scope between the sets of objects has not been accomplished, for one or more group members, the task is repeated; g) The teacher receives the information of the outcome of object exchange of each group in its networked device in order to mediate those groups that need assistance; h) When all the members of the group achieve the scope of the activity, or after a number of pre-specified iterations, the group can proceed to the next activity, said number of pre-specified number of iterations the group members have to answer correctly a question is predetermined: I) in the software; or II) by the teacher in his networked device for each specified group or for all groups simultaneously.

19. A method as claim 8, wherein the display of online transactions is done through a matrix, where the matrix rows correspond to the groups created running the activity, and the columns correspond to the tasks answers that are coded, otherwise, the matrix columns correspond to the groups created running the activity, and the rows correspond to the tasks answers that are coded, where said code is done with symbols: symbol1 if the group solves the scope correctly at the first try, symbol2 if the number of trials are between 2 and ┌n/2┐, (being n the number of the pre specified number of iterations) and symbol3 if the number of trials are between ┌n/2+1┐ and n, where unanswered questions are codified with symbol4, if the rational was not solved with the pre specified number of iterations is also marked with symbol4. Symbol1, symbol2, symbol3 and symbol4 can be any combination of different colors. For instance, symbol1 can be a green colored rectangle, symbol 2 can be a yellows colored rectangle, symbol3 can be a red colored rectangle and symbol4 is a grey colored rectangle.

20. A method as claim 2, wherein collaboration mode includes a method for ordering objects between group members, compromising the following steps: a) Students are arranged in groups, each with a slave device networked in a session to the other members and to the master device of the teacher; b) Each group member receives one or several objects. c) The group members have to find out the correct sequence according to a given scope given to all of them. The scope of the activity can be: I) to order sets of numbers in ascending or descending order.; II) to construct words from syllabus; III) to order objects according to physical dimensions in ascending or descending order; d) One member selects one of the objects presented in his/her networked device and is shown to all the members in their networked devices. e) The previous step is repeated until all objects are selected; f) Afterwards, the networked devices validate the obtained sequence of objects informing the group members through their networked devices and the teacher's machine if the obtained sequence achieves the specified scope; g) When all the correct sequence of objects is obtained or after a number of pre specified iterations, the group can proceed to the next activity, said number of pre-specified number of iterations the group members have to answer correctly a question is predetermined: D in the software; or II) by the teacher in his networked device for each specified group or for all groups simultaneously.

21. A method as claim 8, wherein the display of online transactions is done through a matrix where said matrix rows correspond to the groups created running the activity, and the columns correspond to the tasks answers that are coded, otherwise, the matrix columns correspond to the groups created running the activity, and the rows correspond to the tasks answers that are coded, said code is done with symbols: symbol1 if the group solves the scope correctly at the first try, symbol2 if the number of trials are between 2 and ┌n/2┐, (being n the number of the pre specified number of iterations) and symbol3 if the number of trials are between ┌n/2+1┐ and n, where unanswered questions are codified with symbol4 and if the rational was not solved with the pre specified number of iterations is also marked with symbol4. Symbol1, symbol2, symbol3 and symbol4 can be any combination of different colors, where for instance, symbol1 can be a green colored rectangle, symbol 2 can be a yellow colored rectangle, symbol3 can be a red colored rectangle and symbol4 is a grey colored rectangle.

22. A method as claim 2, wherein the collaboration mode includes a method for answering questions or solving problems collaboratively, compromising the following steps: a) Students are arranged in groups, each with a slave device networked in a session to the other members and to the master device of the teacher; b) The teacher sends to all the students the same problem to solve or question to answer; c) The students write down their own answers on their networked devices screen; d) The group members have to reach an unanimous agreement on which is the right response between the answers they have built on their networked devices screens before replying to the teacher; e) If all of them agree that a different answer, than the one each independently came to is the corresponding one, one of them, selected randomly in the group, writes it down in his/her screen being this answer validated by the other team members; f) If the team members do not agree on the answer, one of them writes one as the group answer, (e) is repeated until an agreement is reached; g) The group answer then is sent to the teacher; h) Once the teacher receives all group answers he selects a set of answers to be discussed by the class; i) The teacher then mediates with all the students the selected answers. The mediation mode between teacher and students can be: I) a poll to the students of the selected answers and after the poll, the teacher can randomly select a student (action done by the networked devices of the c), to endorse his vote in front of the class to bring out a discussion; II) randomly selecting one of the students (action done by the networked devices of the group) from the group that sent the selected answer, to support his reply to provoke a discussion in the class.

23. A method as claim 8, wherein the display of online transactions is done through a matrix where said matrix rows correspond to the groups created running the activity, and the columns correspond to the state of the answering process, otherwise, the matrix columns correspond to the groups created running the activity, and the rows correspond to the state of the answering process.

24. A method as in claim 22, where: 1) The problem to be solved, or question to be answered, can be said loudly to the class or written down by the teacher in his/her master device before sending it to the students; 2) The problem to answer is to reach a final state from a given initial state of a simulation sent by the teacher, solved with a built in simulator in each networked device, where each member of the group can solve the entire simulation or can have a specific role in the simulation, for instance, to change a list of parameters and/or manipulate specific objects predefined by the simulation;

25. A method as in claim 1, wherein the role of the networked devices is a) to present information on each of the participants' electronic display devices, b) transmit information between the group members (online transactions), c) apply the rules of the application stored in each device considering the information of each of the members of the group stored in each of the participants device, and d) transmit the transactions performed by the group to the teachers device in order to store the group log and display the group outcome at each moment to monitor its progress.

26. A method as in claim 25 wherein the information to present to each of the participants is a scenario from a video game, where each group member commands an assigned character on his/her slave device, which has specific features and roles where the information exchanged between devices are the actions of each character, which are reflected in each screen of the devices of the group, where the rules of the applications define the game, which are the tasks and constraints that must be fulfilled by the members of a group, where the tasks are a) objects of the game that have to be sequentially fulfilled by the members of the group following a predefined logic; b) objects of the game that have to be exchanged by the members of the group following a predefined logic; c) objects of the game that have to be selected by the members of the group to fulfill a predefined logic, wherein the constraints are I) coordinated actions between the members of the group that have to be fulfilled, following a predefined logic; II) roles that the members of the group have to fulfill, following a predefined logic; III) ambiance conditions that follow a predefined logic.

27. A method as claim 8, wherein the display of online transactions is done through a matrix, where said matrix rows correspond to the groups created running the activity, and the columns correspond to the tasks answers that are coded, otherwise, the matrix columns correspond to the groups created running the activity, and the rows correspond to the tasks answers that are coded, said code is done with symbols: symbol1 if the group solves the scope correctly at the first try, symbol2 if the number of trials are between 2 and ┌n/2┐, (being n the number of the pre specified number of iterations) and symbol3 if the number of trials are between ┌n/2+1┐ and n, wherein unanswered questions are codified with symbol4. If the rational was not solved with the pre-specified number of iterations is also marked with symbol4. Symbol1, symbol2, symbol3 and symbol4 can be any combination of different color, for instance, symbol1 can be a green colored rectangle, symbol 2 can be a yellow colored rectangle, symbol3 can be a red colored rectangle and symbol4 is a grey colored rectangle.
